(19) United States
(12) Patent Application Publication
(10) Pub. No.: US 2025/0016125 A1
(43) Pub. Date: Jan. 9, 2025

(54) SYSTEMS AND METHODS FOR AUGMENTING ELECTRONIC COMMUNICATIONS

(71) Applicant: Wells Fargo Bank, N.A., San Francisco, CA (US)

(72) Inventors: Tapan Totla, Bangalore (IN); Rameshchandra Bhaskar Ketharaju, Hyderabad (IN)

(21) Appl. No.: 18/171,459

(22) Filed: Feb. 20, 2023

(51) Int. Cl. H04L 51/07; G06Q 30/015; H04L 67/306

(52) U.S. Cl. CPC H04L 51/07; G06Q 30/015; H04L 67/306

(57) ABSTRACT

Systems, apparatuses, methods, and computer program products are disclosed for improving individual interactions with generative artificial intelligence. An example method includes receiving, by communications hardware, an electronic correspondence with an individual and extracting, by language processing circuitry and using an interaction data model, interaction data from the electronic correspondence. The example method also includes generating, by generative model circuitry and using an augmentation generation model, correspondence augmentation data based on augmentation model input data, wherein the augmentation model input data comprises the interaction data and user profile data associated with the individual. The example method also includes generating, by correspondence circuitry, a modified electronic correspondence comprising the correspondence augmentation data and data from the electronic correspondence.

### BACKGROUND

Customer service interactions typically take the form of audio or text conversations, which may frustrate customers and customer service agents due to the inability to convey information as effectively as in face-to-face conversations. This inability to convey nuance and emotional intonation raises challenges for providing effective customer interactions.

### BRIEF SUMMARY

Existing communication technologies used in customer interactions (e.g., email, text messaging, etc.) are often ignored because they are less engaging than direct interaction (e.g., in person or phone conversations). While direct interactions with customers may also be used, they are significantly more costly and are subject to limitations of human customer service agents' ability to interact consistently, for many hours each day, in a way that is agreeable and accommodating to customers. For these reasons, the demands of quality, individualized customer service and scalable, mass interactions with customers are difficult to balance.

While text-to-speech technology exists, the speech generated from parsing the original may be detected as bland or emotionless by customers and thus may be uninteresting to listeners. Such limitations render messages to the customers using these communication technologies to also be bland and non-engaging, which may degrade the perceived experience of the customer and thus the quality of customer interactions. Furthermore, text-only or voice-only communications eliminate a large dimension of human communication, which occurs by seeing facial expressions and gestures, and detecting other nuances that may not be transmitted by text or even voice alone.

To address these limitations of existing communication technologies, generative artificial intelligence (GAI) models may be used to generate improved interactions and engagement for receivers of such communications. An electronic correspondence is received and interaction data, such as emotional state information, is extracted from the electronic correspondence. The extracted interaction data is used to generate correspondence augmentation data, also using user profile data of an individual (e.g., a customer, an employee, or the like) as additional input. The correspondence augmentation is used to modify the original electronic correspondence, which is then transmitted and/or displayed to the individual.

Accordingly, the present disclosure sets forth systems, methods, and apparatuses that improve customer interactions using GAI. Example embodiments disclosed herein improve customer interactions by enabling customer service agents to communicate nonverbal cues and receive nonverbal cues from customers, improving ease of communication. While customer service agents may be able to transmit image or video data to a customer, receiving such data from a customer may be limited due to the customer's available hardware, privacy concerns, or the like. Even if a customer service agent is able to transmit image or video data to the customer, the requirement of being photographed or recorded during interactions may place a greater stress on the customer service agent, making it more difficult to effectively communicate with many customers in a day. By generating image or video data to accompany text and/or audio, example embodiments advantageously overcome these (and other) limitations while also providing improvements to the technical filed of electronic communications through enabling non-conventional and novel forms of electronic communication previously not available and/or utilized in this technical field.

Additionally, example embodiments are not limited to providing image and video data as described, but may further augment communications with generated voice, or other image, emoji, animation, or the like to improve the effectiveness of interactions. Example embodiments also enable fully artificial interactions, (e.g., with a chatbot) to take on a more personal style of interaction by generating facial image, voice audio, or other data to accompany the artificially generated messages.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for generating modified electronic correspondence for improved user interactions with an individual.

FIG. 2 illustrates a schematic block diagram of example circuitry embodying a device that may perform various operations in accordance with some example embodiments described herein.

FIG. 3 illustrates an example flowchart for modifying an electronic correspondence with augmentation data generated by an augmentation model, in accordance with some example embodiments described herein.

FIG. 4 illustrates another example flowchart for obtaining augmentation model input data, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” is used herein to refer to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” is used to refer to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “correspondence augmentation data” refers to audio or visual information that enhances an electronic communication. For example, a text communication may be augmented by providing facial image data of the individual sending the text communication, where the facial image reflects the emotional content of the text message. Similarly, still images, emoji, short animations, videos, or the like may be added to augment a text message. As another example, a voice communication may be augmented with generated video data of a human speaking in synchronization with the audio recording, or static images of a face may alternatively be used. Correspondence augmentation data may reflect the attributes of an individual, referred to as the user profile data for a particular individual, such as the individual's age, gender, height, weight, and other physical characteristics. Correspondence augmentation data may also reflect the content of the electronic communication, referred to as the interaction data, which may include the text of the communication itself and extracted information such as emotional content.

The term “augmentation generation model” refers to a data construct that is configured to describe parameters, hyper-parameters, and/or stored operations of a model to process a set of augmentation model input data to generate correspondence augmentation data. In some embodiments, the augmentation generation model is a trained machine learning model. In particular, the augmentation generation model may be a neural network (e.g., feedforward artificial neural network (ANN), multilayer perceptron (MLP), attention-based models, etc.) and/or a classification machine learning model (e.g., random forest, etc.). The augmentation generation model may be trained based at least in part on correspondence augmentation metadata pertaining to the format of augmentation used (e.g., facial image generation, voice generation, video generation, etc.). Alternatively, the augmentation generation model may be a rules-based model configured to follow a defined set of rules and/or operations to generate correspondence augmentation data. In some embodiments, the augmentation generation model may be a hybrid model which uses both machine learning model techniques and rules-based model techniques. For example, the augmentation generation model may be configured to evaluate whether given correspondence augmentation data is compatible with rules or requirements by a particular embodiment. If the augmentation generation model identifies one or more incompatibilities or inferred mismatches between given correspondence augmentation data and a requirement for the embodiment, the augmentation generation model may generate correspondence augmentation data that address the mismatch between the current configuration and the required configuration as required by the embodiment, either via machine learning techniques or via a rules-based model.

The term “augmentation model input data” refers to data provided as input to the augmentation generation model. The augmentation model input data may include at least the user profile data and interaction data, as described above.

### System Architecture

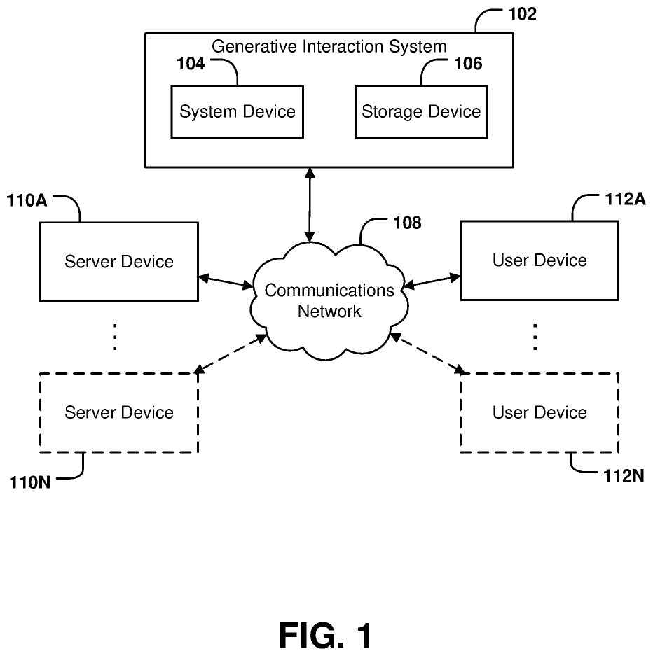

Example embodiments described herein may be implemented using any of a variety of computing devices or servers. To this end, FIG. 1 illustrates an example environment within which various embodiments may operate. As illustrated, a generative interaction system 102 may include a system device 104 in communication with a storage device 106. Although system device 104 and storage device 106 are described in singular form, some embodiments may utilize more than one system device 104 and/or more than one storage device 106. Additionally, some embodiments of the generative interaction system 102 may not require a storage device 106 at all. Whatever the implementation, the generative interaction system 102, and its constituent system device(s) 104 and/or storage device(s) 106 may receive and/or transmit information via communications network 108 (e.g., the Internet) with any number of other devices, such as one or more of server device 110A through server device 110N and/or user device 112A through user device 112N.

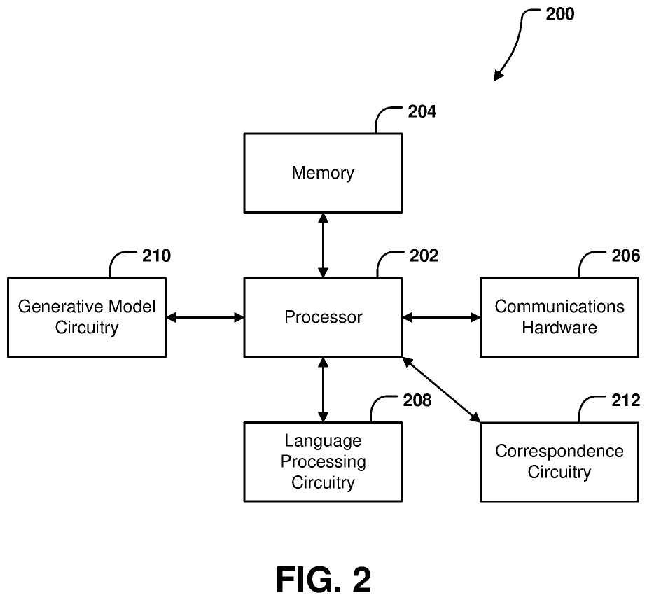

System device 104 may be implemented as one or more servers, which may or may not be physically proximate to other components of generative interaction system 102. Furthermore, some components of system device 104 may be physically proximate to the other components of generative interaction system 102 while other components are not. System device 104 may receive, process, generate, and transmit data, signals, and electronic information to facilitate the operations of the generative interaction system 102. Particular components of system device 104 are described in greater detail below with reference to apparatus 200 in connection with FIG. 2.

Storage device 106 may comprise a distinct component from system device 104, or may comprise an element of system device 104 (e.g., memory 204, as described below in connection with FIG. 2). Storage device 106 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 108). Storage device 106 may host the software executed to operate the generative interaction system 102. Storage device 106 may store information relied upon during operation of the generative interaction system 102, such as various electronic communications that may be used by the generative interaction system 102, data and documents to be analyzed using the generative interaction system 102, or the like. In addition, storage device 106 may store control signals, device characteristics, and access credentials enabling interaction between the generative interaction system 102 and one or more of the server devices 110A-110N or user device 112A-112N.

The one or more server device 110A-110N may be embodied by any storage devices known in the art. Similarly, the one or more user device 112A-112N may be embodied by any computing devices known in the art, such as desktop or laptop computers, tablet devices, smartphones, or the like. The one or more server devices 110A-110N and the one or more user devices 112A-112N need not themselves be independent devices, but may be peripheral devices communicatively coupled to other computing devices.

Although FIG. 1 illustrates an environment and implementation in which the generative interaction system 102 interacts with one or more of server device 110A through server device 110N and/or user device 112A through user device 112N, in some embodiments users may directly interact with the generative interaction system 102 (e.g., via input/output circuitry of system device 104), in which case a separate user device 112 may not be utilized. Whether by way of direct interaction or via a separate user device 112, a user may communicate with, operate, control, modify, or otherwise interact with the generative interaction system 102 to perform the various functions and achieve the various benefits described herein.

### Example Implementing Apparatuses

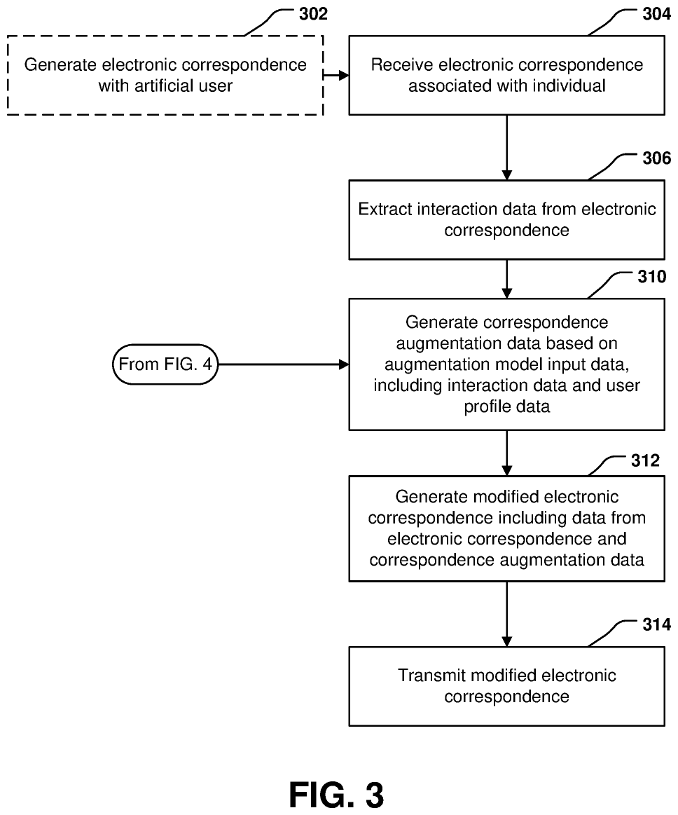

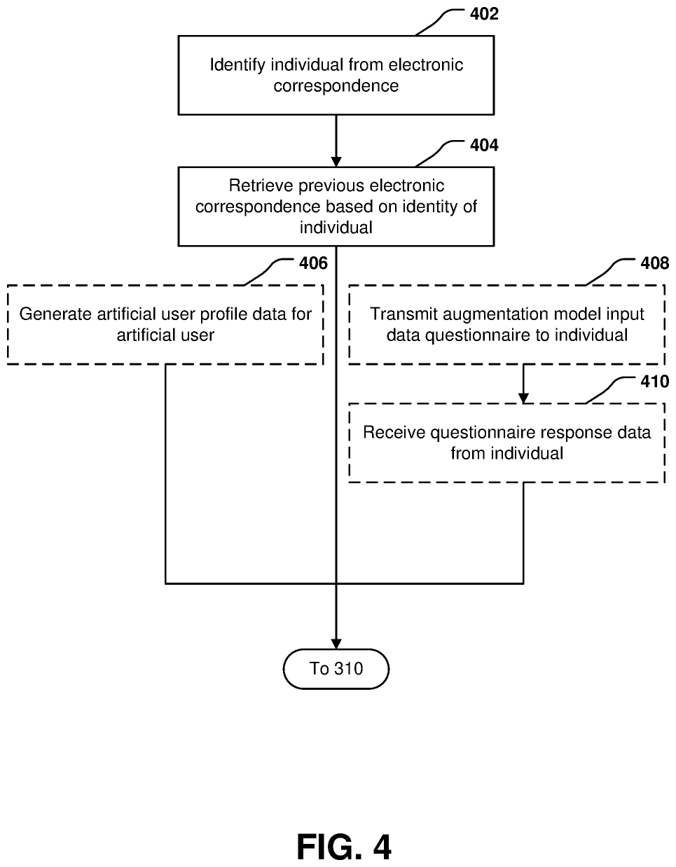

System device 104 of the generative interaction system 102 (described previously with reference to FIG. 1) may be embodied by one or more computing devices or servers, shown as apparatus 200 in FIG. 2. As illustrated in FIG. 2, the apparatus 200 may include processor 202, memory 204, communications hardware 206, language processing circuitry 208, generative model circuitry 210, and correspondence circuitry 212, each of which will be described in greater detail below. While the various components are only illustrated in FIG. 2 as being connected with processor 202, it will be understood that the apparatus 200 may further comprises a bus (not expressly shown in FIG. 2) for passing information amongst any combination of the various components of the apparatus 200. The apparatus 200 may be configured to execute various operations described above in connection with FIG. 1 and below in connection with FIGS. 3-4.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor (e.g., software instructions stored on a separate storage device 106, as illustrated in FIG. 1). In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises a language processing circuitry 208 that analyzes electronic communications to extract interaction data. The language processing circuitry 208 may utilize processor 202, memory 204, or any other hardware component included in the apparatus 200 to perform these operations, as described in connection with FIGS. 3-4 below. The language processing circuitry 208 may further utilize communications hardware 206 to gather data from a variety of sources (e.g., server device 110A through server device 110N or storage device 106, as shown in FIG. 1), and/or exchange data with a user, and in some embodiments may utilize processor 202 and/or memory 204 to extract interaction data.

In addition, the apparatus 200 further comprises a generative model circuitry 210 that generates correspondence augmentation data. The generative model circuitry 210 may utilize processor 202, memory 204, or any other hardware component included in the apparatus 200 to perform these operations, as described in connection with FIGS. 3-4 below. The generative model circuitry 210 may further utilize communications hardware 206 to gather data from a variety of sources (e.g., server device 110A through server device 110N or storage device 106, as shown in FIG. 1), and/or exchange data with a user, and in some embodiments may utilize processor 202 and/or memory 204 to generate correspondence augmentation data.

In addition, the apparatus 200 further comprises a correspondence circuitry 212 that augments and generates electronic correspondence. The correspondence circuitry 212 may utilize processor 202, memory 204, or any other hardware component included in the apparatus 200 to perform these operations, as described in connection with FIGS. 3-4 below. The correspondence circuitry 212 may further utilize communications hardware 206 to gather data from a variety of sources (e.g., server device 110A through server device 110N or storage device 106, as shown in FIG. 1), and/or exchange data with a user, and in some embodiments may utilize processor 202 and/or memory 204 to augment electronic correspondence.

Although components 202-212 are described in part using functional language, it will be understood that the particular implementations necessarily include the use of particular hardware. It should also be understood that certain of these components 202-212 may include similar or common hardware. For example, the language processing circuitry 208, generative model circuitry 210, and correspondence circuitry 212 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus therefore shall be interpreted as necessarily including the particular hardware configured to perform the functions associated with the particular element being described. Of course, while the terms “circuitry” should be understood broadly to include hardware, in some embodiments, the terms “circuitry” may in addition refer to software instructions that configure the hardware components of the apparatus 200 to perform the various functions described herein.

Although the language processing circuitry 208, generative model circuitry 210, and correspondence circuitry 212 may leverage processor 202, memory 204, or communications hardware 206 as described above, it will be understood that any of these elements of apparatus 200 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or memory 204, or communications hardware 206 for enabling any functions not performed by special-purpose hardware elements. In all embodiments, however, it will be understood that the language processing circuitry 208, generative model circuitry 210, and correspondence circuitry 212 are implemented via particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. Thus, some or all of the functionality described herein may be provided by third party circuitry. For example, a given apparatus 200 may access one or more third party circuitries via any sort of networked connection that facilitates transmission of data and electronic information between the apparatus 200 and the third-party circuitries. In turn, that apparatus 200 may be in remote communication with one or more of the other components describe above as comprising the apparatus 200.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus 200, example embodiments are described below in connection with a series of flowcharts.

### Example Operations

Turning to FIGS. 3-4, an example flowchart is illustrated that contains example operations implemented by example embodiments described herein. The operations illustrated in FIGS. 3-4 may, for example, be performed by system device 104 of the generative interaction system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, language processing circuitry 208, generative model circuitry 210, and correspondence circuitry 212, and/or any combination thereof. It will be understood that user interaction with the generative interaction system 102 may occur directly via communications hardware 206, or may instead be facilitated by a separate user device 112, as shown in FIG. 1, and which may have similar or equivalent physical componentry facilitating such user interaction.

Turning to FIG. 3, example operations are shown for modifying an electronic correspondence with augmentation data generated by an augmentation model. As shown by operation 302, the apparatus 200 may include means, such as processor 202, memory 204, communications hardware 206, language processing circuitry 208, or the like, for generating an electronic correspondence with an artificial user. In some embodiments, the original electronic correspondence may not originate from a human user, and an artificial electronic correspondence may be generated. The language processing circuitry 208 may use a language model, pre-determined scripts, or a combination to generate an electronic correspondence. For example, the language processing circuitry 208 may initiate a customer service interaction with a customer with a pre-written welcome script. By way of continued example, after receiving correspondence from the customer, the language processing circuitry 208 may use a language model (e.g., based on neural networks, generative adversarial networks, deep neural networks, convolutional neural networks, or the like, trained with manual or representation learning techniques, which may be supervised or unsupervised) to generate the text of a response to the individual providing the requested customer service activity. In some embodiments, the language processing circuitry 208 may be configured to provide additional information with the electronic correspondence, such as generated emotional state information or additional cues that may be used as input for the augmentation generation model.

As shown by operation 304, the apparatus 200 includes means, such as processor 202, memory 204, communications hardware 206, or the like, for receiving an electronic correspondence associated with an individual. The electronic correspondence may be received via the communications hardware 206 directly by the generative interaction system 102, or from one of user device 112A-112N transmitted over communications network 108. The electronic correspondence may use any of a variety of formats, including text messages, emails, audio recordings, video recordings, or the like. The electronic correspondence may be extracted from a series of messages in a longer chain of correspondence, or may be received alone. In some embodiments, the processor 202 may truncate or trim the electronic correspondence, removing header information, metadata, or the like.

As shown by operation 306, the apparatus 200 includes means, such as processor 202, memory 204, communications hardware 206, language processing circuitry 208, or the like, for extracting, using an interaction data model, interaction data from the electronic correspondence. The interaction data may include classification of emotion data from the electronic correspondence. The interaction data model may be a data structure that may detect interaction data, such as emotion data, from the electronic correspondence. The interaction data model may be a rules-based classification, or in some embodiments may be a machine learning algorithm trained to determine interaction data. The interaction data model may be configured to extract interaction data from the various formats that the electronic correspondence may be provided in, such as text, audio, and/or video. The interaction data may be extracted as a data structure that represents emotional states or other interaction attributes of the electronic correspondence. For example, the interaction data may be a numerical vector with elements representing values of emotional components such as joy, amusement, gratitude, surprise, disapproval, sadness, anger, confusion, or the like.

Turning to FIG. 4, example operations are shown for obtaining augmentation model input data. As shown by operation 402, the apparatus 200 includes means, such as processor 202, memory 204, communications hardware 206, correspondence circuitry 212 or the like, for identifying the individual from the electronic correspondence. The correspondence circuitry 212 may identify the electronic correspondence by extracting user information pertaining to the individual from metadata including header information, labeling, or the like. In some embodiments, the correspondence circuitry 212 may identify the individual from the body of the electronic correspondence by analyzing identifying information provided in the electronic correspondence, for example, if a customer provides identity information on a telephone call to receive customer service. The correspondence circuitry 212 may then match the extracted user information to a user database by looking up a user identifier, customer number, name, birthdate, phone number, and/or any other unique identifying information used to catalog user identities.

As shown by operation 404, the apparatus 200 includes means, such as processor 202, memory 204, communications hardware 206, correspondence circuitry 212 or the like, for retrieving the previous electronic correspondence based on an identity of the individual. The correspondence circuitry 212 may access storage device 106, embodied, for example, in apparatus 200 by memory 204, to retrieve records of previous electronic correspondence. The previous electronic correspondence may be generated by the individual identified in operation 402, and matched to the user identity according to labels, headers, or other metadata associated with the previous electronic correspondence. The correspondence circuitry 212 may process the previous electronic correspondence to prepare it in a format to be used as augmentation model input data, described in detail below in connection with operation 310.

As shown by operation 406, the apparatus 200 may include means, such as processor 202, memory 204, communications hardware 206, generative model circuitry 210, or the like, for generating artificial user profile data for the artificial user, where the user profile data may include the artificial user profile data. The generative model circuitry 210 may be configured to additionally generate artificial user profile data. In some embodiments, the artificial user profile data may act as user profile data, and the user profile data may include the artificial user profile data. The artificial user profile data may be generated purely artificially, for example, by randomly selecting traits for an artificial user based on a random distribution. In some embodiments, the artificial user profile data may be sampled from real user profile data but recombined, randomized, or altered in such a way that it does not relate directly to a particular user profile. In some embodiments, a generative machine learning approach may be used to generate artificial user profile data based on a training dataset including real user profile data. The artificial user profile data may be used to generate augmentation model input data, for example, by providing physical characteristics of an artificial user whose facial image data may be generated to create an appearance of an artificial user to be presented in combination with artificially generated electronic correspondence data.

As shown by operation 408, the apparatus 200 may include means, such as processor 202, memory 204, communications hardware 206, or the like, for transmitting an augmentation model input data questionnaire to the individual. The communications hardware 206 may communicate the questionnaire to the individual operating one of the user devices 112A-112N, or may display the questionnaire using one or more attached display devices of the communications hardware 206. The augmentation model input data questionnaire may request data from the individual that may be used as input for the augmentation generation model, such as the individual's emotional state or other current conditions. In some embodiments, the questionnaire may also request information related to the user profile data, which may be used to reconstruct attributes of the individual's appearance or other persistent attributes.

Finally, as shown by operation 410, the apparatus 200 may include means, such as processor 202, memory 204, communications hardware 206, or the like, for receiving questionnaire response data from the individual. The questionnaire response may have previously been stored in a storage device 106 as set forth in FIG. 1, which may comprise memory 204 of the apparatus 200 or a separate remote storage device (e.g., any of the server devices 110A-110N as shown in FIG. 1) accessible by the apparatus 200 using communications hardware 206 or the like. In such cases, the questionnaire response may be retrieved by the apparatus 200 unilaterally. However, the questionnaire response may be received from a separate device with which the individual interacts (e.g., one of user device 112A through user device 112N), in which case the questionnaire response may be received via communications hardware 206. If the individual interacts directly with the apparatus 200, the questionnaire response may be received via the communications hardware 206. The questionnaire response may include data that may be used as augmentation model input data, as described previously in connection with operation 408.

Returning to FIG. 3, as shown by operation 310, the apparatus 200 includes means, such as processor 202, memory 204, communications hardware 206, generative model circuitry 210 or the like, for generating, using an augmentation generation model, correspondence augmentation data based on augmentation model input data. The augmentation model input data may include the interaction data and user profile data associated with the individual. The correspondence augmentation data may be audio or visual information that enhances an electronic communication. For example, a text communication may be augmented by providing facial image data of the individual sending the text communication, where the facial image reflects the emotional content of the text message. Similarly, still images, emoji, short animations, videos, or the like may be added to augment a text message. For another example, a voice communication may be augmented with generated video data of a human speaking in synchronization with the audio recording, or static images of a face may be used alternatively. Correspondence augmentation data may reflect the attributes of an individual, referred to as the user profile data for a particular individual, such as the individual's age, gender, height, weight, and other physical characteristics. Correspondence augmentation data may also reflect the content of the electronic communication, referred to as the interaction data, which may include the text of the communication itself and extracted information such as emotional content.

The augmentation generation model may be a data construct that is configured to describe parameters, hyper-parameters, and/or stored operations of a model to process a set of augmentation model input data to generate correspondence augmentation data. In some embodiments, the augmentation generation model is a trained machine learning model. In particular, the augmentation generation model may be a neural network (e.g., feedforward artificial neural network (ANN), multilayer perceptron (MLP), attention-based models, etc.) and/or a classification machine learning model (e.g., random forest, etc.). The augmentation generation model may be trained based at least in part on correspondence augmentation metadata pertaining to the format of augmentation used (e.g., facial image generation, voice generation, video generation, etc.). Alternatively, the augmentation generation model may be a rules-based model configured to follow a defined set of rules and/or operations to generate correspondence augmentation data. In some embodiments, the augmentation generation model may be a hybrid model which uses both machine learning model techniques and rules-based model techniques. For example, the augmentation generation model may be configured to evaluate whether given correspondence augmentation data is compatible with rules or requirements by a particular embodiment. If the augmentation generation model identifies one or more incompatibilities or inferred mismatches between given correspondence augmentation data and a requirement for the embodiment, the augmentation generation model may generate correspondence augmentation data that address the mismatch between the current configuration and the required configuration as required by the embodiment, either via machine learning techniques or via a rules-based model.

The generative model circuitry 210, using the augmentation generation model, may generate the correspondence augmentation data by providing the augmentation model input data as input. The augmentation model may be configured by the generative model circuitry 210 or directly by an individual to provide the desired format of augmentation data given the appropriate type of augmentation model input data. The augmentation model input data may be formatted, cleaned, or infilled to provide the appropriate format for input to the augmentation generation model. In some embodiments, the augmentation model input data may be converted to a different form, such as binary or other numerical data, and in some embodiments, the augmentation model input data may be in the form of plain or formatted text, audio, or video. The correspondence augmentation data may be retrieved by the generative model circuitry 210 as the output of the augmentation generation model.

In some embodiments, the augmentation model input data further includes data from a previous electronic correspondence. As shown in FIG. 4 in connection with operations 402 and 404, a previous electronic correspondence may be identified and retrieved based on the identity of the individual. In some embodiments, the previous electronic correspondence may be processed, formatted, filtered, or otherwise prepared to be used as input to the augmentation generation model in the form of augmentation model input data. The data from the previous electronic correspondence may include both the content of the electronic correspondence (e.g., text transcripts, extracted interaction data such as emotional content, or the like) and metadata from the electronic correspondence (e.g., time and date of the correspondence, frequency, categorization and purpose of the electronic correspondence, and the like).

In some embodiments, the augmentation model input data further includes historical user activity data. The generative model circuitry 210 may receive, via communications hardware 206 or other attached circuitry, data records of user activity which may in turn be processed, formatted, infilled, or otherwise prepared for use as augmentation model input data. Several examples include instances where the generative model circuitry 210 may receive tracking cookie data from a partnered ecommerce website, viewing history from a partnered video streaming service, listening history from a partnered music streaming service, location data history from a partnered mapping service. The data received from these example services may be analyzed to provide predictions of the individual's preferred form of electronic correspondence and electronic correspondence augmentation. By way of continued example, an individual's text correspondence may be read by an artificial voice that matches the style of the reader of an individual's recent audiobook, may contain background music of the individual's frequently accessed genre, or may have an artificially generated facial image of the individual's frequently viewed actor from film or television. The historical user activity data may be gathered by any application in communication with the generative interaction system 102, and the generative interaction system 102 may be configured to accept and process historical user activity data from such applications.

In some embodiments, the augmentation generation model includes a generative artificial intelligence (GAI) model. The augmentation generation model may accordingly use unsupervised or semi-supervised learning to generate new images, video, audio, and/or text correspondence augmentation. The augmentation generation model may be configured to process training datasets of existing electronic correspondence related to the desired format of correspondence augmentation, training with images to generate image augmentation, video to generate video augmentation, and so on. The augmentation generation model may include, for example, generative adversarial networks, variational autoencoders, transformers, or other learning models of the like.

In some embodiments, the user profile data includes physical characteristics of an individual. As noted previously, user profile data may include attributes such as the individual's age, gender, height, weight, and other physical characteristics. The physical characteristics of the individual may be used to generate correspondence augmentation data that presents an image, video, or voice of the individual approximating the individual's actual characteristics without requiring capture and transmission of the actual individual's video, speech, or the like. Generating augmentation data reflective of the individual's physical characteristics may circumvent limitations in recording actual human voice or video data, for example, in situations where privacy practices prevent capture of such information, where bandwidth limitations make such capture infeasible, where hardware to capture such information is unavailable, or in other similar scenarios. To this end, in some embodiments, the correspondence augmentation data is facial image data, voice data, facial video data, or the like, which may represent or stand in for real voice, facial images, or video transmissions.

As shown by operation 312, the apparatus 200 includes means, such as processor 202, memory 204, communications hardware 206, correspondence circuitry 212, or the like, for generating a modified electronic correspondence including the correspondence augmentation data and data from the electronic correspondence. The correspondence circuitry 212 may receive the correspondence augmentation data from the generative model circuitry 210 (which may be generated in example operation 310). The correspondence augmentation data may be paired, concatenated, merged, overlayed, or otherwise combined with the electronic correspondence to produce the modified electronic correspondence. For example, the electronic correspondence may be a text message directed to a customer, and the user profile data may relate to a customer service agent. The modified correspondence may be a text message presented with facial image data reflecting the tone and emotions of the text message displayed to one side of the text, where the facial image data matches the physical appearance of the customer service agent, conveyed by the customer service agent's user profile data.

In another example, the modified electronic correspondence may be an audio message, and the data from the electronic correspondence may be the text of the electronic correspondence. The original electronic correspondence may be received via communications hardware 206, for example, as text from an attached input device, and the modified electronic correspondence may be an audio message generated to match certain vocal qualities of the individual based on user profile data from the individual (which may include previously analyzed voice samples to detect tone, pitch, and the like). In some embodiments, the electronic correspondence is a voice message, and extracting interaction data from the electronic correspondence further uses a natural language processing model. The data from the electronic correspondence may also be the extracted transcript from the voice message. The natural language processing model may output information including a text transcript of the voice message of the electronic correspondence, and may additionally provide data relating to the tone and emotional content of the message as augmentation model input data. The modified electronic correspondence may then include generated image, video, and/or audio data extracted from the original voice recording.

Finally, as shown by operation 314, the apparatus 200 includes means, such as processor 202, memory 204, communications hardware 206, or the like, for transmitting the modified electronic correspondence. In some embodiments, the modified electronic correspondence may be transmitted to a user via the communications network 108, in an instance where the user is operating one of the user devices 112A-112N, as depicted in FIG. 1. In some embodiments, the system device 104 of the generative interaction system 102, embodied in the apparatus 200, may display the modified electronic correspondence. In this instance it will be understood that the modified electronic correspondence is transmitted directly via the communications hardware 206 to the user to be displayed, played, or otherwise delivered to the user, either directly or by means of the attached hardware of the communications hardware 206.

FIGS. 3-4 illustrates operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be embodied by software instructions. In this regard, the software instructions which embody the procedures described above may be stored by a memory of an apparatus employing an embodiment of the present invention and executed by a processor of that apparatus. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a computer-readable memory that may direct a computing device or other programmable apparatus to function in a particular manner, such that the software instructions stored in the computer-readable memory produce an article of manufacture, the execution of which implements the functions specified in the flowchart blocks. The software instructions may also be loaded onto a computing device or other programmable apparatus to cause a series of operations to be performed on the computing device or other programmable apparatus to produce a computer-implemented process such that the software instructions executed on the computing device or other programmable apparatus provide operations for implementing the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

In some embodiments, some of the operations described above in connection with FIGS. 3-4 may be modified or further amplified. Furthermore, in some embodiments, additional optional operations may be included. Modifications, amplifications, or additions to the operations above may be performed in any order and in any combination.

As described above, example embodiments provide methods and apparatuses that enable improved interaction with users or customers. Example embodiments thus provide tools that overcome problems associated with providing personalized customer service by electronic communication (e.g., text or voice) to large numbers of customers. In particular, different from conventional electronic communication that simply rely on just the text and voice, example embodiments improve conventional forms of electronic communication by using GAI to automatically augment electronic communications with more expressive forms of communication, such as facial data, voice data, or the like. By avoiding the need for human agents to provide image, audio, or visual recoding, example embodiments avoid technical and privacy issues around the collection of this data, and furthermore reduce stress on customer service workers, avoiding the need to perform consistently in front of cameras or other devices during customer interactions.

As these examples all illustrate, example embodiments contemplated herein provide technical solutions that solve real-world problems faced during customer service interactions using conventional forms of electronic communication (e.g., text or voice). In particular, recently emerging technology involving GAI has unlocked new avenues to solving these problems that historically were not available, and example embodiments described herein thus represent a technical solution to these real-world problems (e.g., improvements to the existing technical field of electronic communications).

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
receiving, by communications hardware, an electronic correspondence associated with an individual;
extracting, by language processing circuitry and using an interaction data model, interaction data from the electronic correspondence, wherein the interaction data comprises one or more attributes, and wherein the one or more attributes comprise at least one emotion attribute;
generating, by generative model circuitry and using an augmentation generation model, first correspondence augmentation data based on augmentation model input data, wherein the augmentation model input data comprises the interaction data and user profile data associated with the individual;
determining, by the generative model circuitry and using the augmentation generation model, whether a mismatch exists between the first correspondence augmentation data and a required type of correspondence augmentation data; and
generating, by correspondence circuitry and in absence of the mismatch, a modified electronic correspondence comprising the first correspondence augmentation data and data from the electronic correspondence.

2. The method of claim 1, further comprising:
receiving, by the communications hardware, questionnaire response data from the individual;
wherein the augmentation model input data further comprises the questionnaire response data.

3. The method of claim 1, further comprising:
transmitting, by the communications hardware, the modified electronic correspondence.

4. The method of claim 1, wherein the augmentation model input data further comprises the data from a previous electronic correspondence.

5. The method of claim 4, further comprising:
identifying, by the correspondence circuitry, the individual from the electronic correspondence; and
retrieving, by the correspondence circuitry, the previous electronic correspondence based on an identity of the individual.

6. The method of claim 1, wherein the correspondence augmentation data is facial image data.

7. The method of claim 1, wherein the augmentation generation model comprises a generative artificial intelligence model.

8. The method of claim 1, wherein the user profile data comprises physical characteristics of the individual.

9. The method of claim 1, wherein the augmentation model input data further comprises historical user activity data.

10. The method of claim 1, wherein the electronic correspondence is a text message directed to a customer, wherein the user profile data relates to a customer service agent.

11. The method of claim 10, wherein the modified electronic correspondence is an audio message, and the data from the electronic correspondence includes one or more texts included in the electronic correspondence.

12. The method of claim 1, wherein the electronic correspondence is a voice message, wherein extracting the interaction data from the electronic correspondence further uses a natural language processing model, wherein the data from the electronic correspondence is an extracted transcript from the voice message.

13. The method of claim 1, wherein the individual is an artificial user, and wherein the method further comprises:
generating, by the generative model circuitry, artificial user profile data for the artificial user, wherein the user profile data comprises the artificial user profile data; and
generating, by the language processing circuitry, the electronic correspondence.

14. An apparatus comprising:
communications hardware configured to receive an electronic correspondence associated with an individual;
language processing circuitry configured to extract, using an interaction data model, interaction data from the electronic correspondence, wherein the interaction data comprises one or more attributes, and wherein the one or more attributes comprise at least one emotion attribute;
generative model circuitry configured to:
generate, using an augmentation generation model, first correspondence augmentation data based on augmentation model input data, wherein the augmentation model input data comprises the interaction data and user profile data associated with the individual, and
determine, using the augmentation generation model, whether a mismatch exists between the first correspondence augmentation data and a required type of correspondence augmentation data; and
correspondence circuitry configured to generate, in absence of the mismatch, a modified electronic correspondence comprising the first correspondence augmentation data and data from the electronic correspondence.

15. The apparatus of claim 14, wherein the augmentation model input data further comprises the data from a previous electronic correspondence.

16. The apparatus of claim 15, wherein the correspondence circuitry is further configured to:
identify the individual from the electronic correspondence; and
retrieve the previous electronic correspondence based on an identity of the individual.

17. The apparatus of claim 14, wherein the correspondence augmentation data is facial image data.

18. The apparatus of claim 14, wherein the augmentation generation model comprises a generative artificial intelligence model.

19. The apparatus of claim 14, wherein the user profile data comprises physical characteristics of the individual.

20. A computer program product comprising at least one non-transitory computer-readable storage medium storing software instructions that, when executed, cause an apparatus to:
receive an electronic correspondence associated with an individual;
extract, using an interaction data model, interaction data from the electronic correspondence, wherein the interaction data comprises one or more attributes, and wherein the one or more attributes comprise at least one emotion attribute;
generate, using an augmentation generation model, first correspondence augmentation data based on augmentation model input data, wherein the augmentation model input data comprises the interaction data and user profile data associated with the individual;
determine, using the augmentation generation model, whether a mismatch exists between the first correspondence augmentation data and a required type of correspondence augmentation data; and
generate, in absence of the mismatch, a modified electronic correspondence comprising the first correspondence augmentation data and data from the electronic correspondence.
